(19) United States
(12) Patent Application Publication
(10) Pub. No.: US 2024/0196987 A1
(43) Pub. Date: Jun. 20, 2024

(54) Method of Determining a Dielectric Response of an Aerosol Generating Article

(71) Applicant: JT International SA, Geneva (CH)

(72) Inventors: Christoph Lungenschmied, Vienna (AT); Alec Wright, Guildford (GB)

(73) Assignee: JT International SA, Geneva (CH)

(21) Appl. No.: 18/288,055

(22) PCT Filed: Apr. 13, 2022
(86) PCT No.: PCT/EP2022/059882

§ 371 Date: Oct. 24, 2023

(30) Foreign Application Priority Data
Apr. 28, 2021 (EP) 21170926.6

(51) Int. Cl. A24F 40/53; A24F 40/20; A24F 40/51; G01F 13/00

(52) U.S. Cl. CPC A24F 40/53; A24F 40/20; A24F 40/51; G01F 13/00

(57) ABSTRACT

An aerosol generating device comprises a first terminal and a second terminal disposed in a heating chamber such that they contact different parts of an aerosol generating article. An alternating voltage is applied between the first and second terminals and characteristics of a current that flows between them are measured. The characteristics are used to determine a dielectric response of the aerosol generating article at the applied frequency. The dielectric response comprises both a conductive component and a capacitive component and may be used to identify a state of the aerosol generating article, for example whether it is correctly inserted or the amount of a volatile substance such as nicotine that it contains. By comparing the dielectric responses before and after the device is used, it is possible to estimate an amount of the volatile substance that a user of the device has inhaled.

### TECHNICAL FIELD

The present disclosure relates generally to an aerosol generating device for heating an aerosol generating substrate to generate an aerosol for inhalation by a user of the aerosol generating device. The present disclosure is particularly applicable to a portable (hand-held) aerosol generating device. Such devices heat, rather than burn, an aerosol generating substrate, e.g., tobacco or other suitable materials, by conduction, convection, and/or radiation to generate an aerosol for inhalation by a user.

### TECHNICAL BACKGROUND

The popularity and use of reduced-risk or modified-risk devices (also known as aerosol generating devices or vapour generating devices) has grown rapidly in recent years as an alternative to the use of traditional tobacco products. Various devices and systems are available that heat or warm aerosol generating substances to generate an aerosol for inhalation by a user.

A commonly available reduced-risk or modified-risk device is the heated substrate aerosol generating device, or so-called heat-not-burn device. Devices of this type generate an aerosol or vapour by heating an aerosol generating substrate to a temperature typically in the range 150° C. to 300° C. Heating the aerosol generating substrate to a temperature within this range, without burning or combusting the aerosol generating substrate, generates a vapour which typically cools and condenses to form an aerosol for inhalation by a user of the device.

Currently available aerosol generating devices can use one of a number of different approaches to provide heat to the aerosol generating substrate. One such approach is to employ an induction heating system. In such a device, an induction coil is provided in the device and an inductively heatable susceptor is provided to heat the aerosol generating substrate. Electrical energy is supplied to the induction coil when a user activates the device which in turn generates an alternating electromagnetic field. The susceptor couples with the electromagnetic field and generates heat which is transferred, for example by conduction, to the aerosol generating substrate and an aerosol is generated as the aerosol generating substrate is heated. Another approach is to employ a resistive heating system, in which current is supplied directly to a heater element. The heating element generates heat which is transferred, for example by conduction, to the aerosol generating substrate. The susceptor or heating element may surround the aerosol generating substrate and transfer heat to an outer surface of the aerosol generating substrate. Alternatively, the susceptor or heating element may be in the form of a blade that becomes embedded in the aerosol generating substrate when the aerosol generating substrate is inserted into the aerosol generating device.

In most such aerosol generating devices, the heater operates in a predetermined manner when commanded to start, for example in response to the user pushing a start button or in response to the device determining by means of an airflow sensor that the user has inhaled a puff through the device. Optimal operation therefore depends on the user selecting an appropriate aerosol generating substrate and inserting it correctly into the aerosol generating device. There exists a desire for a “smarter” aerosol generating device that can detect a characteristic or state of the inserted substrate and can use the detected state or characteristic to improve the operation of the device or to provide relevant information to the user.

Published patent application WO 2017/051006 A1 discloses an aerosol generating device comprising a power supply, at least one heater and a cavity for receiving an aerosol-generating article. The device further comprises a first electrode and a second electrode spaced apart from the first electrode so that at least a portion of the aerosol generating article is received between them. A controller of the device is configured to terminate the supply of power to a heater when a measured electrical load between the first electrode and the second electrode exceeds a predetermined threshold. The electrical load may comprise at least one of a resistive load and a capacitive load. The change in the measured electrical load between the first electrode and the second electrode is stated to give an indication of the amount of one or more volatile compounds remaining in the aerosol generating article.

### SUMMARY OF THE DISCLOSURE

According to a first aspect of the disclosure, an aerosol generating device comprises:
a heating chamber configured to receive an aerosol generating article: and
a first terminal and a second terminal, the first and second terminals being disposed in the heating chamber such that, when an aerosol generating article is received in the heating chamber, the first and second terminals respectively contact different parts of the aerosol generating article:
and a method of operating the aerosol generating device comprises:
(a) inserting an aerosol generating article into the heating chamber;
(b) applying an alternating voltage at an applied frequency between the first and second terminals;
(c) measuring characteristics of a current that flows between the first and second terminals while the alternating voltage is being applied; and
(d) using the measured characteristics of the current to determine a dielectric response of the aerosol generating article at the applied frequency.

The dielectric response can be expressed in a complex form as Y=G+iωC, where Y denotes the admittance, G is the conductance, i²=−1, ω=2πf is the angular frequency and C is the capacitance. It is known that increasing moisture levels in tobacco increase both the real and imaginary part of the admittance. The dielectric response is hence indicative of the moisture level in the tobacco at any frequency. While water is expected to play a disproportionate role in the dielectric response due to its large dielectric constant, the presence/absence of humectants and other volatile substances are expected to contribute to the change in admittance as the tobacco material is heated.

The measured characteristics of the current may comprise the amplitude of the current and the phase shift between the voltage and the current. These quantities are straightforward to measure and can be used to express the current as a complex number. From a complex number expressed in terms of amplitude and phase, it is easy to derive the real and imaginary components, equivalent to converting between polar and rectangular co-ordinates. By comparing the complex current with the applied (real) voltage, the dielectric response (complex admittance) can be determined.

The step of determining a dielectric response preferably comprises determining both a conductive component and a capacitive component of the dielectric response. Whereas examples in the prior art have applied a direct or low frequency voltage to measure only the resistance or conductance, or have used a high frequency voltage to measure only the capacitance, the present invention preferably operates at intermediate frequencies such that both the conductive and capacitive components make a non-negligible contribution to the determined dielectric response. As both the real and the imaginary components of admittance carry information about the content of volatile substances in the substrate more information can be derived by measuring the complex quantity at a convenient intermediate applied frequency. This frequency can be chosen as one where the dielectric response is most sensitive to changes in the tobacco that occur during use of the device. An intermediate frequency may also be more convenient to generate and process with low-cost electronics.

Preferably, the applied frequency is in the range 100 Hz to 1 MHz. More preferably, the applied frequency is in the range 1 kHz to 100 kHz. Inductive heating generally works in a similar range of frequencies so the technology to generate such frequencies in aerosol generating devices already exists and it may be possible to share some electronic components between the heating circuit and the circuit for determining the dielectric response.

In one variant of the method according to the invention, steps (b) and (c) are carried out with different applied frequencies: then step (d) comprises using the measured characteristics of the current at the respective applied frequencies to determine the dielectric response of the aerosol generating article. At different frequencies, the contribution of the real and imaginary components to the dielectric response will be different so carrying out the determination of the dielectric response at different frequencies provides independent measurements of those components and permits errors to be reduced.

As previously explained, water present in the substrate is expected to make the largest contribution to its dielectric response due to its large dielectric constant. While it may be useful to know the water content of the substrate, the amount of other volatile substances such as nicotine will often be of greater interest. To a first approximation, it is assumed that the amount of water in the substrate is a good indication of the amount of volatile substances. However, it would be desirable to be able to determine the content of volatiles independently. Water and other volatile substances may contribute differently to the admittance of the substrate at different frequencies of the applied voltage, therefore carrying out the determination of the dielectric response at different frequencies provides a possible way of distinguishing the content of the volatile substances in the substrate from the content of water.

A temperature sensor may be provided for measuring the temperature of the aerosol generating article: whereby the measured temperature can be used with the measured characteristics of the current to determine the dielectric response of the aerosol generating article. It is known that dielectric response is partly temperature-dependent so measuring the temperature allows a correction to be made and enables a more reliable comparison of determinations made at different times or under different conditions. This is particularly important if the determination of the dielectric response is performed while the aerosol generating article is being heated.

The determined dielectric response may be used to identify a state of the aerosol generating article: and a signal may be outputted to indicate the state of the article to a user. Additionally or alternatively, the aerosol generating device may be controlled in a manner dependent on the state of the article.

In one example, the method of determining the dielectric response of an aerosol generating article may in fact determine a state that the article has been inserted incorrectly in the heating chamber. In such a case, the device can output a signal to the user to indicate the incorrect insertion and/or can prevent the heater of the device from being operated.

In another example, the method may determine that the aerosol generating article is unsuitable for use in the device, for example because its volatile substances are depleted as a result of the article already having been used. Again, the device can output a signal to the user to indicate the state of the article and/or it can prevent the heater of the device from being operated. Alternatively, it may be possible to adapt the operation of the device, such as its operating temperature, to compensate for the low volatile content of the article.

The admittance between the first and second terminals will be affected not only by the substrate but also by the presence of any residues or other contaminants in the heating chamber. Therefore, if the determination of the dielectric response produces unexpected results, this may be interpreted as an indication that the device requires cleaning. This information may also be signalled to the user or employed to control or prevent the operation of the device.

Another variant of the method according to the invention is to carry out steps (b) to (d) after insertion of the aerosol generating article into the heating chamber to determine a first dielectric response: apply heat to the aerosol generating article in the heating chamber, for example during a smoking session; then to repeat steps (b) to (d) to determine a second dielectric response. The second dielectric response may be compared with the first dielectric response to determine a change of state of the article and the device may output a signal to indicate the change of state of the article or may control its operation in a manner dependent on the change of state of the article.

In a typical example, the change of state of the article is a depletion of volatile substances in the article. As a result of this variant of the method, it may be determined that the article is exhausted and should no longer be used.

A preferred method according to the invention comprises using the determined change of state of the article to estimate an amount of at least one volatile substance inhaled by a user of the device between the determination of the first and second dielectric responses. The at least one volatile substance may include nicotine and it is highly interesting for many users of aerosol generating devices to be able to determine how much nicotine (or other substance) they have consumed during the smoking session, for example if they are trying to control or reduce their intake of the substance. It may also be of interest to the manufacturer of the device or the aerosol generating article to know how much of the volatile substance is consumed during their real-world use. The device may be configured to transmit the data to a remote location such as a smartphone, from where it may be relayed to the manufacturer. Alternatively, the data may be stored in the device for retrieval at a subsequent time.

A possible further step in the method comprises recording a number of puffs inhaled by the user of the device between the determination of the first and second dielectric responses: and using the determined change of state of the article and the recorded number of puffs to estimate an amount of the least one volatile substance inhaled by the user per puff. Such information may be useful to enable the user to estimate their consumption of the volatile substance by counting puffs during future use of the device. It may also be of interest to the manufacturer of the device or the aerosol generating article to learn more about the real-world use of their products.

The method according to the present invention may be carried automatically by the aerosol generating device, for example immediately upon insertion of an aerosol generating article, or it may be carried out only when demanded by the user.

According to a further aspect of the present invention, an aerosol generating device comprises:
a heating chamber configured to receive an aerosol generating article;
a first terminal and a second terminal, the first and second terminals being disposed in the heating chamber such that, when an aerosol generating article is received in the heating chamber, the first and second terminals respectively contact different parts of the aerosol generating article;
a voltage source; and
a controller configured to carry out the aforementioned method when an aerosol generating article is inserted into the heating chamber.

Each of the first terminal and the second terminal may be generally planar, having a length and a width measured in the plane of the terminal: the first and second terminals being disposed in parallel to one another on opposite sides of the heating chamber such that the aerosol generating article may be received between them, and such that the first and second terminals are separated by a perpendicular distance less than the length and the width of the terminals. The fact that each terminal has a width and a length does not imply that it must be rectangular. The length may be defined as the greatest dimension of the terminal measured in any direction parallel to the plane, and the width may be defined as the greatest dimension of the terminal measured in a direction perpendicular to the length and parallel to the plane. The length and the width may be equal, e.g. in the case of square or circular terminals.

This configuration allows the aerosol generating device to be used with an aerosol generating article having a card-like form, i.e. with a thickness substantially less than its width and length, which slides easily between the terminals. The terminals can extend over a large area of the aerosol generating substrate so that the measurement of dielectric response includes a large proportion of the substrate. The relatively large area and small separation of the terminals gives rise to a large capacitance between them, which results in a sensitive measurement of the dielectric response.

Unless the context clearly requires otherwise, throughout the description and the claims, the words “comprise”, “comprising”, and the like, are to be construed in an inclusive as opposed to an exclusive or exhaustive sense; that is to say, in the sense of “including, but not limited to”.

In this specification, terms such as “upper” and “lower” refer to the orientation of the device shown in the exemplary drawings and are not intended to limit a device according to the invention to being manufactured, stored, transported or used in any particular orientation.

### BRIEF DESCRIPTION OF THE DRAWINGS

FIG. 1 is a diagrammatic cross-sectional view of an aerosol generating system comprising an aerosol generating device and an aerosol generating article positioned in a heating chamber of the aerosol generating device;

FIG. 2 is a partial diagrammatic cross-sectional view of a first embodiment of an aerosol generating system in which the method according to the invention may be performed: and

FIG. 3 is a partial diagrammatic cross-sectional view of a second embodiment of an aerosol generating system in which the method according to the invention may be performed.

FIG. 4 is schematic perspective view of a third embodiment of an aerosol generating system in which the method according to the invention may be performed.

### DETAILED DESCRIPTION OF EMBODIMENTS

Embodiments of the present disclosure will now be described by way of example only and with reference to the accompanying drawings.

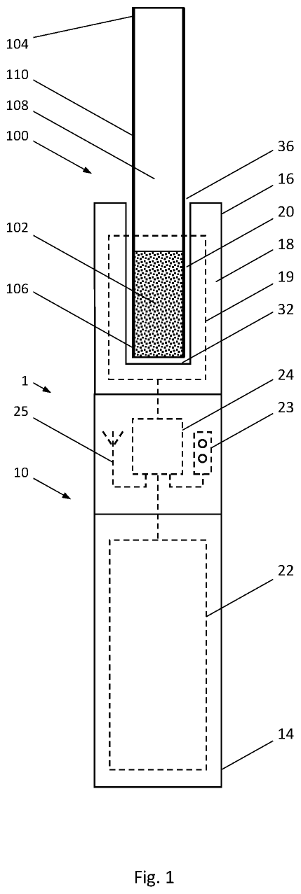

Referring initially to FIG. 1, there is shown diagrammatically an example of an aerosol generating system 1. The aerosol generating system 1 comprises an aerosol generating device 10 and an aerosol generating article 100 for use with the device 10. The aerosol generating device 10 can have any shape that is sized to fit the components described in the various embodiments set out herein and to be comfortably held by a user unaided, in a single hand.

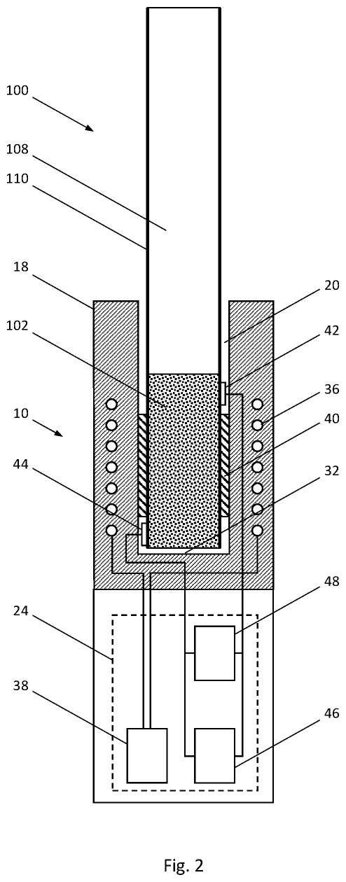

A first end 14 of the aerosol generating device 10, shown towards the bottom of FIG. 1, is described for convenience as a distal, bottom, base or lower end of the aerosol generating device 10. A second end 16 of the aerosol generating device 10, shown towards the top of FIG. 2, is described as a proximal, top or upper end of the aerosol generating device 10. During use, the user typically orients the aerosol generating device 10 with the first end 14 downwards and/or in a distal position with respect to the user's mouth and the second end 16 upwards and/or in a proximal position with respect to the user's mouth.

The aerosol generating device 10 comprises a heating chamber 18. The heating chamber 18 defines an interior volume in the form of a cavity 20 having a substantially cylindrical cross-section for receiving an aerosol generating article 100. The cavity 20 of the heating chamber 18 is open towards the second end 16 of the aerosol generating device 10. The heating chamber 18 comprises a heater 19 for heating an aerosol generating that is received in the cavity 20. The heater may take various forms but its general location is indicated by dashed lines in FIG. 1. The heating chamber 18 has a longitudinal axis defining a longitudinal direction and is formed of a heat-resistant plastics material, such as polyether ether ketone (PEEK). The aerosol generating device 10 further comprises a power source 22, for example one or more batteries which may be rechargeable, and a controller 24, which couples the power source to the heater. The controller 24 may also be connected to a user interface 23 comprising inputs such as a power button for receiving commands from a user and/or outputs such as indicator lights, a display screen or an audible or vibratory alarm for providing information to the user. The controller may also be interfaced with an antenna 25 for wireless communication with a remote device such as the user's smartphone, which can be used for input and output, as well as for relaying data between the aerosol generating device 10 and its manufacturer.

The heating chamber 18, and specifically the cavity 20, is arranged to receive a correspondingly shaped generally cylindrical or rod-shaped aerosol generating article 100. Typically, the aerosol generating article 100 comprises a pre-packaged aerosol generating substrate 102. The aerosol generating article 100 is a disposable and replaceable article (also known as a “consumable”) which may, for example, contain tobacco as the aerosol generating substrate 102. The aerosol generating article 100 has a proximal end 104 (or mouth end) and a distal end 106. The distal end 106 is inserted into the heating chamber 18 of the aerosol generating device 10 so that at least the aerosol generating substrate 102 is contained within the heating chamber 18. The aerosol generating article 100 further comprises a mouthpiece segment 108 positioned downstream of the aerosol generating substrate 102. At least part of the mouthpiece segment 108 projects from the heating chamber 18 so that the proximal end 104 of the aerosol generating article 100 is accessible to be taken into the mouth of a user. When the aerosol generating device 10 applies heat to the aerosol generating article 100, heated vapour is emitted from the aerosol generating substrate 102. As inhalation by the user draws air towards the proximal end 104 of the aerosol generating article 100, the vapour cools and condenses as it passes through the mouthpiece segment 108 to form an aerosol with characteristics suitable for inhalation. The mouthpiece segment 108 may further comprise a filter (not shown) to remove particles or drops above a certain size from the airstream.

The aerosol generating substrate 102 and the mouthpiece segment 108 are arranged in coaxial alignment inside a wrapper 110 (e.g., a paper wrapper) to hold the components in position to form the rod-shaped aerosol generating article 100. The wrapper 110 typically does not cover the ends 104,106 of the aerosol generating article 100 in order that air can flow through the aerosol generating article 100 from the distal end 106 to the proximal end 104.

In the illustrated embodiments of the invention, the heating chamber 18 comprises a closed base 32. That is, the heating chamber 18 is cup shaped. This can ensure that air drawn from the open first end 26 is guided through the aerosol generating substrate 102.

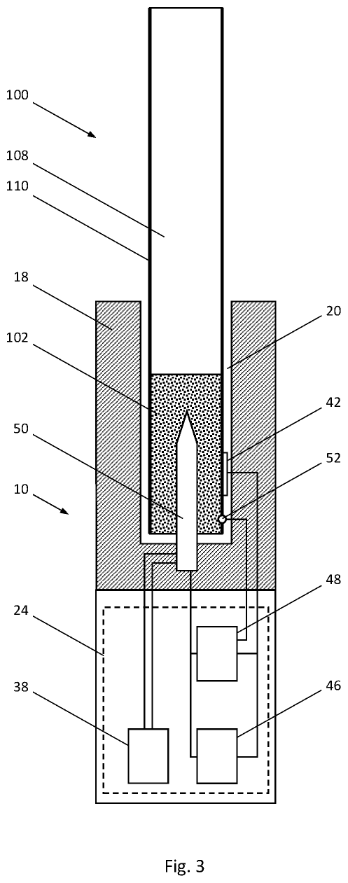

FIGS. 2 and 3 illustrated exemplary embodiments of the present invention. They schematically show a heating chamber 18, in the cavity 20 of which an aerosol generating device 102 is received. The power source 22 is not shown in FIGS. 2 and 3.

In the embodiment of FIG. 2, an induction heater is provided for heating the aerosol generating article received in the cavity 20. A helical induction coil 36 surrounds the cavity 20 and is spaced from it. Means for mounting the induction coil 36 are typically mounted on an outer wall of the heating chamber 18. A heating controller 38 controls the supply of electrical power from the power source 22 to the induction coil 36. The heating controller 38 includes, among other electronic components, an inverter which is arranged to convert a direct current from the power source 22 into an alternating high-frequency current for the induction coil 36.

A susceptor 40 is located inside the cavity 20 of the heating chamber 18. Different configurations of susceptor 40 are known and will not be described here. Typically, the susceptor 40 comprises one or more elements disposed around an inner wall of the heating chamber 18, which are arranged to be in contact or in close proximity with the wrapper 110 of an aerosol generating article 100 that is received in the cavity 20. When the heating controller 38 supplies power to the heating coil 36 at a suitable frequency, it generates alternating magnetic fields, which induce currents to flow in the susceptor 40. The material and structure of the susceptor 40 are chosen such that eddy currents induced in the susceptor 40 cause power to be dissipated as heat. The heat is transferred by conduction, convection and/or radiation to the substrate 102 of the aerosol generating article 100 and causes volatile substances in the substrate 102 to vaporize. The volatile substances are entrained in the flow of air drawn through the aerosol generating article to form an aerosol that can be inhaled by the user, as previously described.

In accordance with the present invention, the aerosol generating device 10 shown in FIG. 2 further comprises a first terminal 42 and a second terminal 44 disposed in the cavity 20 of the heating chamber 18 such that the first and second terminals 42,44 respectively contact different parts of the aerosol generating article 100. The first and second terminals 42,44 are connected to a voltage generator 46, which draws power from the power source 22 and selectively applies an alternating voltage across the first and second terminals 42,44 at one or more desired frequencies. The first and second terminals 42,44 are further connected to an admittance analyser 48, which measures the current flowing between the first and second terminals 42,44 while the alternating voltage is being applied to them and uses characteristics of the measured current to determine the admittance or dielectric response of the aerosol generating article 100. The dielectric response in turn provides information about the state or characteristics of the substrate 102, as will be described below.

The first terminal 42 and the second terminal 44 are preferably disposed such that they contact parts of the aerosol generating article 100 that are relatively widely separated from one another. As a result, current flowing between the first and second terminals 42,44 samples a substantial part of the substrate 102. In the illustrated example of FIG. 2, the first terminal 42 is disposed adjacent to the wrapper 110 of the aerosol generating article 100 close to the proximal end of the substrate 102. The second terminal 44 is disposed adjacent to the substrate 102 at the distal end 106 of the aerosol generating article 100. It is preferred that the second terminal 44 is disposed at or near the distal end 106 of the aerosol generating article 100 so that, if the aerosol generating article 100 is not fully inserted into the cavity 20, it will not make full contact with the second terminal 44. This will affect the admittance measured between the first and second terminals 42,44 so the incorrect insertion of the aerosol generating article 100 can be detected by the admittance analyser 48. The aerosol generating device 10 can then emit a signal to alert the user to the incorrect insertion of the aerosol generating article 100. When the aerosol generating article 100 is in a state of incorrect insertion, the heating controller 38 may be prevented from supplying power to the heating coil 36.

In the illustrated example of FIG. 2, the second terminal 44 is disposed, like the first terminal 42, adjacent to the wrapper 110 on the radially outer surface of the aerosol generating article 100. In an alternative embodiment of the invention (not illustrated), the second terminal 44 could be disposed at the end 32 of the heating chamber 18, adjacent to the end surface of the aerosol generating article 100. This would ensure that the article 100 would make no contact with the second terminal 44 unless fully and correctly inserted into the heating chamber 18. On the other hand, it would potentially interfere with airflow from the cavity 20 into the article 100.

FIG. 3 is generally similar to FIG. 2 and the same reference numerals are used for like elements of the aerosol generating system. The principal difference relates to the heating components of the aerosol generating device 10, which in this embodiment of the invention comprise a blade 50 that extends in the proximal direction from the base 32 of the heating chamber 18. When an aerosol generating article 100 is inserted into the cavity 20 of the heating chamber 18, the blade 50 becomes embedded in the aerosol generating substrate 102 so that heat can be applied to the substrate 102 directly from inside. Unlike the inductive heating of FIG. 2, in this embodiment the blade 50 is a resistive heating element with a direct electrical connection to the heating controller 38.

A further difference from the embodiment of FIG. 2 is that the blade 50 also serves as the second terminal of the circuit for measuring the dielectric response of the aerosol generating article 100. As in FIG. 2, the first terminal 42 is disposed in contact with the wrapper 110 of the aerosol generating article 100 so that when the voltage generator 46 generates an alternating voltage, current flows between the first terminal 42 and the blade 50, passing generally through just one half of the aerosol generating substrate 102. The first terminal 42 could be made to extend around part or all of the circumference of the aerosol generating article 100 in order that the measured current samples a greater portion of the aerosol generating substrate 102.

Because the blade 50 serves both as the heating element and as the second terminal, it is simpler to configure the system such that it switches between heating and measurement modes, whereby the blade 50 is not used to measure the dielectric response of the aerosol generating article 100 while it is also supplying heat. However, it is technically feasible and potentially beneficial to measure the dielectric response at the same time as heating.

The embodiment of FIG. 3 further comprises a temperature sensor 52, which is disposed adjacent to the aerosol generating substrate 102 and is used to measure the temperature of the substrate 102 when the dielectric response is determined. The admittance of the substrate 102 is partly dependent on its temperature so the temperature measured by the sensor 52 can be used as a correction factor in the determination of the dielectric response. This is particularly significant if the dielectric response is determined while the heater is in operation. The temperature sensor 52, may for example be a thermocouple, a thermistor, a resistance temperature detector (RTD) or any other suitable instrument for determining temperature.

FIGS. 2 and 3 are used to illustrate various possible features of an aerosol generating system 1 according to the invention but it should be understood that the features are not limited to being used in the particular combinations shown in those Figures. For example, the induction coil 36 of FIG. 2 may be used with a susceptor that is embedded in the substrate 102 in the same manner as the blade 50 of FIG. 3. Conversely, instead of the embedded blade 50 of FIG. 3, a resistance heater may comprise a heating element that only contacts the exterior of the aerosol generating article 100 like the susceptor 40 illustrated in FIG. 2. The present invention is concerned with measuring the dielectric response of the aerosol generating substrate 102 and is substantially independent of the means employed to heat the substrate 102. Although FIG. 3 illustrates only that a resistive heating element in the form of a blade 50 can serve as the second terminal of the circuit for measuring the dielectric response, it is equally possible for that second terminal to be provided by a heating element that only contacts the exterior of the aerosol generating article 100 and/or by a susceptor of an inductive heater. There exist some aerosol generating devices in which the substrate is heated by being sandwiched between two heater plates. In such examples, the two heater plates could also serve, respectively, as the first and second terminals 42,44 of the present invention.

Although the heating controller 38, voltage generator 46 and admittance analyser 48 are illustrated as discrete components, they may share common elements. For example, at least their control functions may all be performed by a common processor that serves as the general controller 24 for the aerosol generating system 1. If the system 1 is operated through a wireless interface with a remote device such as a smartphone, then the admittance analyser 48 may be used only to measure the characteristics of the current between the first and second terminals 42,44, with at least part of the determination of the dielectric response being performed on the remote device.

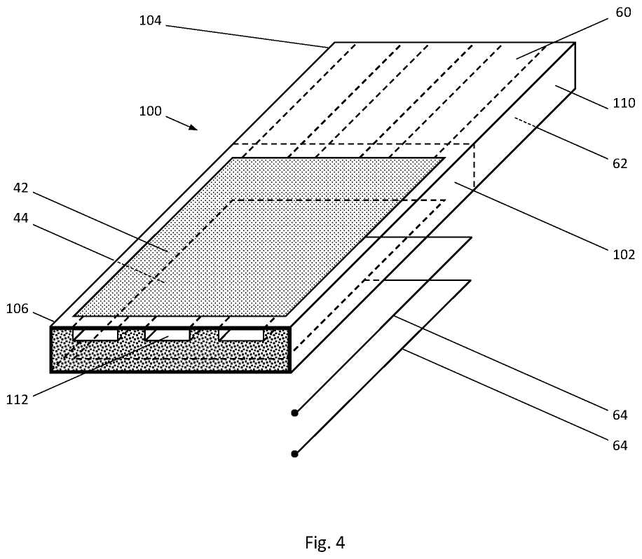

FIG. 4 shows a third example of an aerosol generating system according to the invention. For clarity, the heating chamber itself is not shown in FIG. 4. In this example, the aerosol generating article 100 is of a flattened, rectangular form, having a thickness (measured vertically in the drawing) that is much less than its width or length. As before, the aerosol generating article 100 is enclosed by a wrapper 110 and contains an aerosol generating substrate 102 at the distal end 106. Air channels 112 are formed in the substrate 102 and extend through the substrate from the distal end 106 to the communicate with an airflow path that emerges at the proximal end 104 of the aerosol generating article 100. The drawing illustrates three air channels 112 formed at an upper surface of the substrate 102 but the number and location of the channels 112 may differ in other embodiments.

This shape of aerosol generating article 100 provides large, flat upper and lower surfaces 60,62. The first terminal 42 and second terminal 44 used for measuring the dielectric response of the article 100 are mounted in the heating chamber (not shown) of the aerosol generating device 10 so as to be respectively adjacent to the upper and lower surfaces 60,62 of the aerosol generating article 100. The terminals 42,44 are planar, they are of generally equal size and shape, and they face one another in the configuration of a capacitor with the aerosol generating substrate 102 as the dielectric between them. Although FIG. 4 is not drawn to scale, it does show that the terminals 42,44 are separated by a distance that is significantly smaller than their length and width. Wires 64 couple the first and second terminals 42,44 to the voltage source and admittance analyser (not shown in FIG. 4). As illustrated, the first and second terminals 42,44 extend over a substantial proportion of the areas of the respective upper and lower surfaces of the aerosol generating substrate 102, whereby the measurement of dielectric response samples a substantial proportion of the volume of the substrate 102. This configuration provides the possibility that the first and second terminals 42,44 may also serve as heating elements for the substrate 102. Most simply, the terminals 42,44 may be used at certain times to apply heat to the substrate 102 and at different times—e.g. before and after a vaping session—to measure the dielectric response. However, with suitable control electronics, it is possible to carry out a measurement of the dielectric response at the same time as the terminals 42,44 are being used to heat the substrate 102.

It will be understood that the flattened form of the aerosol generating article 100 shown in FIG. 4 does not exclude an arrangement of the first and second terminals 42,44 similar to that in FIG. 2, whereby the terminals 42,44 each extend over a smaller area, the first terminal 42 being positioned adjacent to one of the surfaces 60,62 of the article 100 near the proximal end of the substrate 102 and the second terminal 44 being positioned adjacent to the other of the surfaces 60,62 of the article 100 near the distal end of the substrate 102.

Although exemplary embodiments have been described in the preceding paragraphs, it should be understood that various modifications may be made to those embodiments without departing from the scope of the appended claims. Thus, the breadth and scope of the claims should not be limited to the above-described exemplary embodiments.

Any combination of the above-described features in all possible variations thereof is encompassed by the present disclosure unless otherwise indicated herein or otherwise clearly contradicted by context.

1. A method of operating an aerosol generating device, the aerosol generating device including:
a heating chamber configured to receive an aerosol generating article; and
a first terminal and a second terminal, the first and second terminals being disposed in the heating chamber such that, when an aerosol generating article is received in the heating chamber, the first and second terminals respectively contact different parts of the aerosol generating article, the method comprising:
(a) inserting the aerosol generating article into the heating chamber;
(b) applying an alternating voltage at an applied frequency between the first and second terminals;
(c) measuring characteristics of a current that flows between the first and second terminals while the alternating voltage is being applied; and
(d) using the measured characteristics of the current to determine a dielectric response of the aerosol generating article at the applied frequency.

2. The method according to claim 1, wherein the step of measuring characteristics of the current comprises measuring an amplitude of the current and measuring a phase shift between the voltage and the current.

3. The method according to claim 1, wherein the step of determining a dielectric response comprises determining both a conductive component and a capacitive component of the dielectric response.

4. The method according to claim 1, wherein the applied frequency is in a range of 100 Hz to 1 MHz.

5. The method according to claim 1, wherein the applied frequency is in a range of 1 kHz to 100 kHz.

6. The method according to claim 1, comprising carrying out steps (b) and (c) with different applied frequencies; wherein step (d) comprises using the measured characteristics of the current at the different frequencies to determine the dielectric response of the aerosol generating article.

7. The method according to claim 1, further comprising measuring a temperature of the aerosol generating article; wherein step (d) comprises using the measured characteristics of the current and the measured temperature to determine the dielectric response of the aerosol generating article.

8. The method according to claim 1, further comprising using the determined dielectric response to identify a state of the aerosol generating article; and outputting a signal to indicate the state of the article or controlling the aerosol generating device in a manner dependent on the state of the article.

9. The method according to claim 8, wherein the identified state of the aerosol generating article is that the article has been inserted incorrectly in the heating chamber.

10. The method according to claim 1, comprising:
carrying out steps (b) to (d) after insertion of the aerosol generating article into the heating chamber to determine a first dielectric response;
applying heat to the aerosol generating article in the heating chamber;
repeating steps (b) to (d) to determine a second dielectric response; and
comparing the second dielectric response with the first dielectric response to determine a change of state of the article; and
outputting a signal to indicate the change of state of the article or controlling the aerosol generating device in a manner dependent on the change of state of the article.

11. The method according to claim 10, wherein the change of state of the article is a depletion of volatile substances in the article.

12. The method according to claim 11, further comprising using the determined change of state of the article to estimate an amount of at least one volatile substance inhaled by a user of the device between the determination of the first and second dielectric responses.

13. The method according to claim 12, further comprising recording a number of puffs inhaled by the user of the device between the determination of the first and second dielectric responses; and using the determined change of state of the article and the recorded number of puffs to estimate an amount of the least one volatile substance inhaled by the user per puff.

14. An aerosol generating device comprising:
a heating chamber configured to receive an aerosol generating article;
a first terminal and a second terminal, the first and second terminals being disposed in the heating chamber such that, when an aerosol generating article is received in the heating chamber, the first and second terminals respectively contact different parts of the aerosol generating article;
a voltage source; and
a controller configured to:
(a) apply an alternating voltage at an applied frequency between the first and second terminals;
(b) measure characteristics of a current that flows between the first and second terminals while the alternating voltage is being applied; and
(c) use the measured characteristics of the current to determine a dielectric response of the aerosol generating article at the applied frequency.

15. The aerosol generating device according to claim 14, wherein:
each of the first terminal and the second terminal is generally planar, having a length and a width measured in the plane of the terminal; and
the first and second terminals are disposed in parallel to one another on opposite sides of the heating chamber such that the aerosol generating article may be received between them, and such that the first and second terminals are separated by a perpendicular distance less than the length and the width of the terminals.
